(19) United States
(12) Patent Application Publication
(10) Pub. No.: US 2013/0063347 A1
(43) Pub. Date: Mar. 14, 2013

(54) METHOD OF PROCESSING SIGNAL OF PORTABLE COMPUTER AND PORTABLE COMPUTER USING THE METHOD

(71) Applicant: Hong-kil PARK, Suwon-si (KR)

(72) Inventor: Hong-kil PARK, Suwon-si (KR)

(73) Assignee: Samsung Electronics Co., Ltd, Suwon-si (KR)

(21) Appl. No.: 13/603,845

(22) Filed: Sep. 5, 2012

(30) Foreign Application Priority Data
Sep. 8, 2011 (KR) 10-2011-0091318

(51) Int. Cl. G06F 3/033

(52) U.S. Cl. 345/157

(57) ABSTRACT

A portable computer includes a display unit to display a predetermined screen, a pointing module including at least one pointing button to point or select a predetermined point on the predetermined screen, a keyboard unit including at least one key button disposed adjacent to the at least one pointing button, and a detecting sensor module to detect at least one of approach and contact to the at least one key button, and a system controller to determine whether to perform an operation corresponding to manipulation of the at least one pointing button based on a detecting result of the detecting sensor module when the manipulation of the at least one pointing button is detected.

### CROSS-REFERENCE TO RELATED APPLICATIONS

This application claims the benefit of priority under 35 U.S.C. §119 from Korean Patent Application No. 10-2011-0091318, filed on Sep. 8, 2011, in the Korean Intellectual Property Office, the disclosure of which is incorporated herein in its entirety by reference.

### BACKGROUND OF THE INVENTION

1. Field of the Invention

The present general inventive concept relates to a method of processing a signal of a portable computer and a portable computer using the method, and more particularly, to a method of processing a signal generated while manipulating a pointing button of a portable computer, and a portable computer using the method.

2. Description of the Related Art

A computer displays a graphic user interface (GUI) on a display unit. A user may manipulate the computer via the displayed GUI. For example, the user may input or output predetermined data through the displayed GUI, and may generate a predetermined command. In detail, the user may move a pointer indicating a predetermined point of the GUI, and select a predetermined menu item displayed at a location where the moved pointer is displayed. The predetermined menu item may be a shortcut menu or the like of a predetermined program.

The pointer may be manipulated by using a mouse externally connected to the computer. The pointer may be moved by moving the mouse, and the predetermined menu item may be selected by clicking a mouse button.

Also, a touch pad or a pointing device including a pointing stick, which can move the pointer, may be used instead of the mouse in a portable computer. The touch pad or the pointing device may be disposed within a keyboard of the portable computer.

When portable computers are miniaturized in size, spaces between pointing buttons and key buttons are decreased, thereby increasing a possibility of pressing an unintended button.

Thus, a method and apparatus are required to prevent a signal processing malfunction by pressing an unintended button of a keyboard unit or pointing buttons.

### SUMMARY OF THE INVENTION

The present general inventive concept provides a method of processing a signal of a portable computer, and a portable computer using the method, which prevent an unintended operation that may be generated due to an inadvertent or unintended manipulation of a button.

The present general inventive concept also provides a method of processing a signal of a portable computer, and a portable computer using the method, which prevent an unintended operation due to an inadvertent or unintended manipulation generated between a pointing button and a key button adjacent to the pointing button.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable computer including a display unit to display a predetermined screen, a pointing module including at least one pointing button and to point and select a predetermined point on the predetermined screen, a keyboard unit including at least one key button disposed adjacent to the at least one pointing button, and a detecting sensor module to detect at least one of approach and contact to the at least one key button, and a system controller to determine whether to perform or not perform an operation corresponding to manipulation of the at least one pointing button based on a detecting result of the detecting sensor module when the at least one pointing button is manipulated.

The system controller may not perform the operation corresponding to the manipulation of the at least one pointing button if the at least one of the approach and contact is detected.

The system controller may perform the operation corresponding to the manipulation of the at least one pointing button if at least one of the approach and contact is not detected.

The pointing module may include a pointing sensing unit including a pointing stick to point at the predetermined point, and to detect the predetermined point pointed by the pointing stick. The at least one pointing button may select a menu item at the predetermined point or to perform a predetermined process on the menu item at the predetermined point. The pointing module may further include a pointing controller to detect the manipulation of the at least one pointing button, and to generate and transmit a command corresponding to the detected manipulation of the at least one pointing button to the system controller.

The system controller may monitor the detecting result of the detecting sensor module, and perform or not perform an operation corresponding to the command.

The system controller may not perform the operation corresponding to the command if at least one of the approach and contact is detected and may perform the operation corresponding to the predetermined command if at least one of the approach and contact is not detected, based on the monitored detecting result.

The pointing controller may monitor the detecting result of the detecting sensor module, and ignore the manipulation of the at least one pointing button or performs the operation corresponding to the manipulation of the at least one pointing button based on the monitored detecting result.

The pointing controller may ignore the manipulation of the at least one pointing button if at least one of the approach and contact is detected, and perform the operation corresponding to the manipulation of the at least one pointing button if at least one of the approach and contact is not detected.

The pointing controller may not generate the command corresponding to the manipulation of the at least one pointing button if at least one of the approach and contact is detected, and may generate the command corresponding to the manipulation of the at least one pointing button if at least one of the approach and contact is not detected.

The detecting sensor module may include a proximity sensor module, wherein the proximity sensor module may include: a contact plate to detect the approach or contact of a user, a capacitor to be charged or discharged based on whether the contact plate detected the approach or contact of the user, and a detection signal generator to generate a detection signal based on a voltage charged in the capacitor.

The detection signal generator may generate the detection signal having an activated level if the at least one of the approach and contact is detected, and may not generate the detection signal or may generate the detection signal having a deactivated level if the at least one of the approach and contact is not detected.

The detecting sensor module may be disposed between the at least one pointing button and the at least one key button disposed adjacent to the at least one pointing button.

The detecting sensor module may be disposed inside the at least one key button disposed adjacent to the at least one pointing button.

The foregoing and/or other features and utilities of the present general inventive concept may also be achieved by providing a method of processing a signal of a portable computer including a keyboard including at least one pointing button and at least one key button disposed adjacent to the at least one pointing button, the method including detecting at least one of approach and contact to the at least one key button by using a detecting sensor module, detecting manipulation of the at least one pointing button, and determining of whether to perform or not perform an operation corresponding to the manipulation of the at least one pointing button based on the detecting result of the detecting sensor module.

The foregoing and/or other features and utilities of the present general inventive concept may also be achieved by providing a non-transitory computer-readable medium to contain computer-readable codes as a program to execute a method of processing a signal in a portable computer having a keyboard including at least one pointing button and at least one key button disposed adjacent to the at least one pointing button, the method including detecting at least one of approach and contact to the at least one key button by using a detecting sensor module, detecting manipulation of the at least one pointing button, and performing or not performing an operation corresponding to the manipulation of the at least one pointing button based on the detecting result of the detecting sensor module.

The foregoing and/or other features and utilities of the present general inventive concept may also be achieved by providing a portable computer including a display unit to display a predetermined screen, a keyboard unit comprising a plurality of buttons to generate an input to the predetermined screen, and a detecting sensor module disposed adjacent one of the buttons to detect at least one of approach and contact to the one key button, and a system controller to determine an operation of another button according to the detecting result of the detecting sensor module when the another button is activated.

The system controller may determine a priority to be given to the another key button according to the detecting result of the detecting sensor module when the one key button and the another button are activated.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1A and 1B are diagrams illustrating a portable computer having a pointing stick;

FIG. 2 is a flowchart illustrating a method of processing a signal of a portable computer, according to an embodiment of the present general inventive concept;

FIG. 3 is a block diagram illustrating a portable computer according to an embodiment of the present general inventive concept;

FIGS. 4A and 4B are diagrams illustrating a pointing module and a keyboard unit of the portable computer of FIG. 3;

FIG. 5 is a diagram illustrating a detecting sensor module of the portable computer of FIG. 3;

FIG. 6 is a block diagram illustrating a portable computer according to an embodiment of the present general inventive concept;

FIG. 7 is a flowchart illustrating a method of processing a signal of a portable computer, according to an embodiment of the present general inventive concept; and

FIG. 8 is a flowchart illustrating a method of processing a signal of a portable computer, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Hereinafter, a method of processing a signal of a portable computer, and a portable computer using the method, according to embodiments of the present invention will be described in detail with reference to accompanying drawings. Expressions such as “at least one of,” when preceding a list of elements, modify the entire list of elements and do not modify the individual elements of the list.

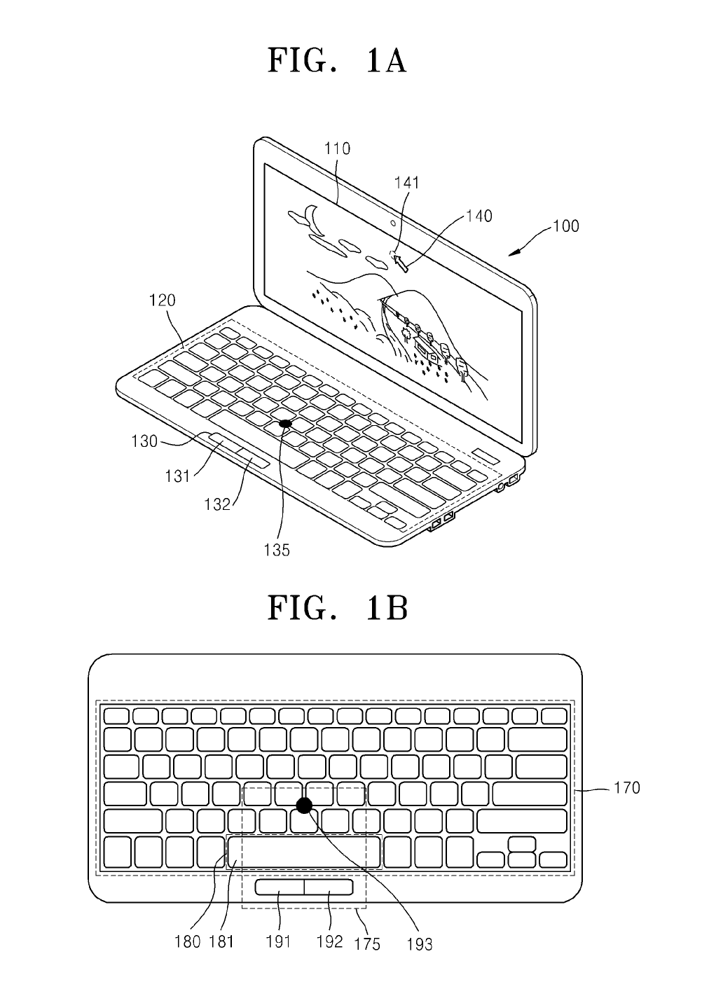

FIGS. 1A and 1B are diagrams of a portable computer 100 using a pointing stick 135. FIG. 1A is an overall diagram illustrating the portable computer 100, and FIG. 1B is a diagram illustrating a keyboard unit 170 and a predetermined region 175 having a pointing device of the portable computer 100 of FIG. 1A.

As portable computers become miniaturized in size or have different dimensions according to at least one of a display image ratio, a display unit to display an image, a keyboard unit, an input/output method, and so on, a pointing device including a pointing stick is required to have a space less than or different from a space of a touch pad, for example.

FIG. 1A illustrates the portable computer 100, as an example. However, the present general inventive concept is not limited thereto. The present general inventive concept may be used in any type of a computer apparatus, for example, a tablet computer having keys disposed adjacent to each other or a mobile device having keys disposed close to each other such that an intended key can be selected during selection of a key thereof.

Referring to FIG. 1A, the portable computer 100 includes a display unit 110 and a keyboard unit 120. The keyboard unit 120 may be formed as a main body of the portable computer 100 to have a circuit unit to process data and to generate a signal corresponding to an image displayed on the display unit 110 according to the processed data and/or manipulation of a key thereof. The display unit 110 may include another circuit unit to display the image according to the signal generated from the main body. The display unit 110 may be rotatable with respect to the keyboard unit 120. However, it is possible that the display unit 110 and the keyboard 120 may be formed as a single monolithic integrated body as a computer apparatus having a display and a plurality of keys as input elements. The keys may be a mechanical key, such as a key button, or an electronic key, such as a touch pad key.

The display unit 110 displays a predetermined screen thereon. The predetermined screen may be a graphic user interface (GUI), a window image including at least one icon, or a menu image having a menu screen with one or more menu items. A pointer 140 is located on the predetermined screen.

The pointing device may be disposed on a same plane as keys of the keyboard unit 120 and may include the pointing stick 135 and one or more pointing buttons 130. The pointing buttons 130 may be used to select an item corresponding to a point pointed by the pointing stick 135. In FIG. 1A, the pointing buttons 130 includes two pointing buttons 131 and 132.

A user may move the pointer 140 by using the pointing stick 135 in order to select a menu item, for example, displayed at a predetermined point 141.

As illustrated in FIG. 1B, the keyboard unit 170, a pointing stick 183, and pointing buttons 191 and 192 of FIG. 1B respectively correspond to the keyboard unit 120, the pointing stick 135, and the pointing buttons 131 and 132 of FIG. 1A.

Referring to FIG. 1B, the pointing stick 193 may be between key buttons included in the keyboard unit 170. Also, the pointing buttons 191 and 192 may be disposed at a lower center of the keyboard unit 170. However, the present general inventive concept is not limited thereto. It is possible that the pointing buttons 191 and 192 may be disposed inside the keyboard unit 170, at a side of the keyboard unit 170, or at a corner portion of the keyboard unit 170.

As the portable computer 100 is miniaturized, the sizes of pointing buttons 191 and 192 may also be decreased, and the pointing buttons 191 and 192 are more adjacently disposed to the keyboard unit 170. Thus, a key area 180 disposed adjacent to at least one of the pointing buttons 191 and 192 may include at least one key button 181 to be pressed when the user wants to press the pointing button 192. It is possible that the pointing button 192 disposed adjacent to the key button 180 may be pressed when the user wants to press the key button 180.

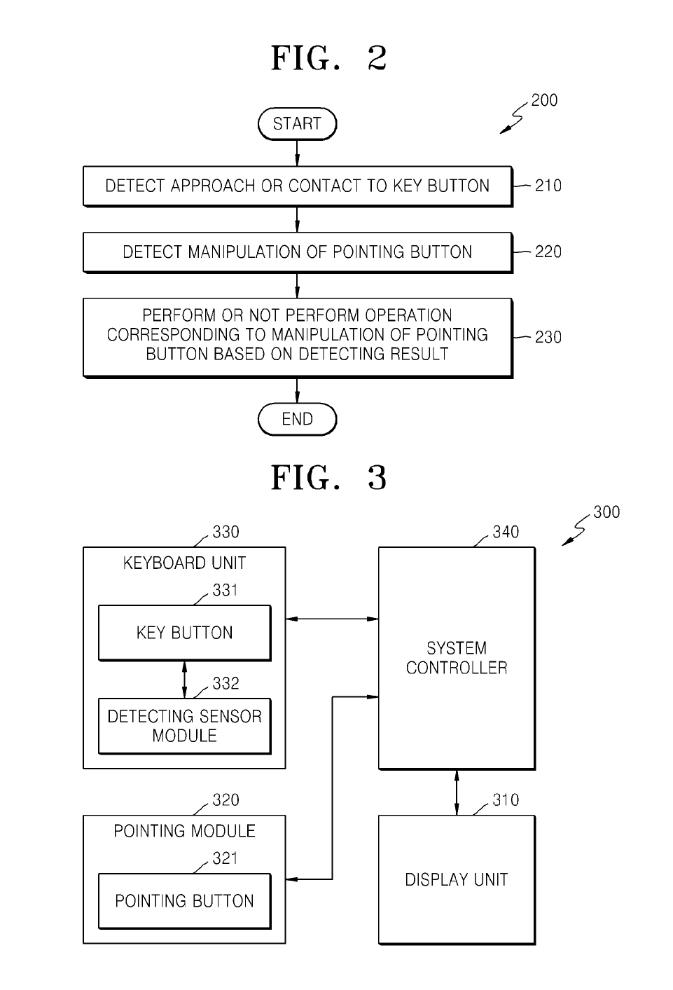

FIG. 2 is a flowchart illustrating a method 200 of processing a signal of a portable computer, according to an embodiment of the present general inventive concept.

Referring to FIG. 2, the method 200 may be performed in a portable computer including at least one pointing button and at least one key button disposed adjacent to the at least one pointing button. It is possible that the method 200 can be performed in a computer apparatus having at least two keys disposed adjacent to each other such that a user manipulation of one key can affect an operation of the other key. The method 200 may be a method of determining whether a priority is given to one of two key inputs when at least two keys are touched, selected, or pressed to correspond to respective operations of the two key inputs in a computer apparatus.

The method 200 detects at least one of approach and/or contact to the at least one key button adjacent to the at least one pointing button by using a detecting sensor module, in operation 210. The detecting sensor module may monitor any existence of an object disposed adjacent to the key button. The object may be a user, a user finger, or a user hand, for example, disposed adjacent to the corresponding key button. It is possible that the detecting sensor module may detect an object disposed between the key button and the pointing button. It is also possible that the detecting sensor module may detect an object disposed in an area corresponding to the key button.

In operation 220, manipulation of the at least one pointing button is detected. In FIG. 2, operation 220 is performed after operation 210, but operations 210 and 220 may be simultaneously performed. Alternatively, operation 210 may be performed after operation 220.

An operation corresponding to the manipulation of the pointing button is performed or not performed based on the detecting result of the detecting sensor module, in operation 230.

The method 200 may be performed by a portable computer 300 according to an embodiment of the present general inventive concept that will be described later with reference to FIG. 3. Also, an apparatus to perform the method 200 of FIG. 2 may have the same technical aspects and operational configurations as the portable computer 300 of FIG. 3. However, the present general inventive concept is not limited thereto. The method 200 of FIG. 2 can be performed in various types of apparatuses having two or more keys disposed adjacent to one another and having a higher priority given to at least one of the keys.

FIG. 3 is a block diagram illustrating the portable computer 300 according to an embodiment of the present general inventive concept.

Referring to FIG. 3, the portable computer 300 includes a display unit 310, a pointing module 320, a keyboard unit 330, and a system controller 340. The pointing module 320 and the keyboard unit 330 may be included in a keyboard main body corresponding to a surface of the portable computer as illustrated in FIG. 1B.

The display unit 310 displays a predetermined screen. The predetermined screen may include a graphic user interface (GUI) as described above, a predetermined image screen, or a run screen of a predetermined program.

The pointing module 320 includes at least one pointing button 321, and is used to point at or select a predetermined point on the predetermined screen displayed on the display unit 310.

The pointing module 320 may move a pointer (not illustrated) on the predetermined screen displayed on the display unit 310 and may select a predetermined menu item displayed at a point (position) where the pointer is located. If the pointing button 321 is manipulated, for example, touched, selected, or pressed, the pointing module 320 may detect the manipulation of the pointing button 321, and notify the system controller 340 that the pointing button 321 is manipulated. Also, the pointing module 320 may generate a command corresponding to the manipulation of the pointing button 321, and transmit the command to the system controller 340.

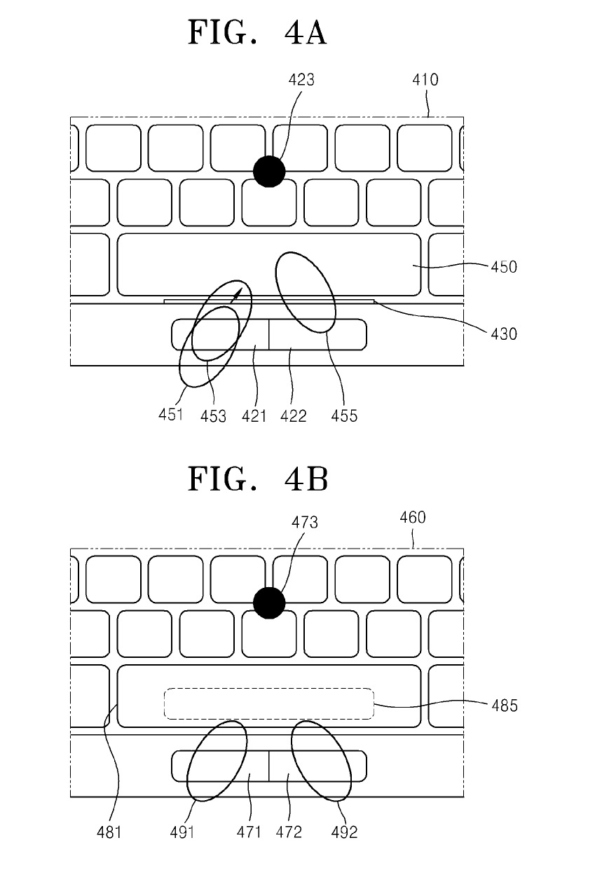

For example, a user may move a pointer by using a pointing stick, and select a menu item displayed at a point where the pointer is located by clicking a pointing button. The pointing button may command a predetermined operation of the selected menu item other than selecting the menu item. The structure and operation of the pointing module 320 will be described in detail later with reference to FIG. 4.

Operation 220 of FIG. 2 may be performed by the pointing module 320 of FIG. 3. It is possible that operation of FIG. 2 may be performed by the pointing module 320 and the system controller 340 of FIG. 3.

The keyboard unit 330 includes at least one key buttons 331 disposed adjacent to the at least one pointing button 321 to input a signal representing a character, a number, a function, a symbol, a command, and so on, to a main body thereof to control the function of the portable computer 300, and a detecting sensor module 332 to detect at least one of approach and contact to the at least one key button 331. The keyboard unit 330 may further include a plurality of key buttons (not illustrated) that are not disposed adjacent to the pointing button 321. The key button 331 disposed adjacent to the pointing button 321 will be described hereinafter.

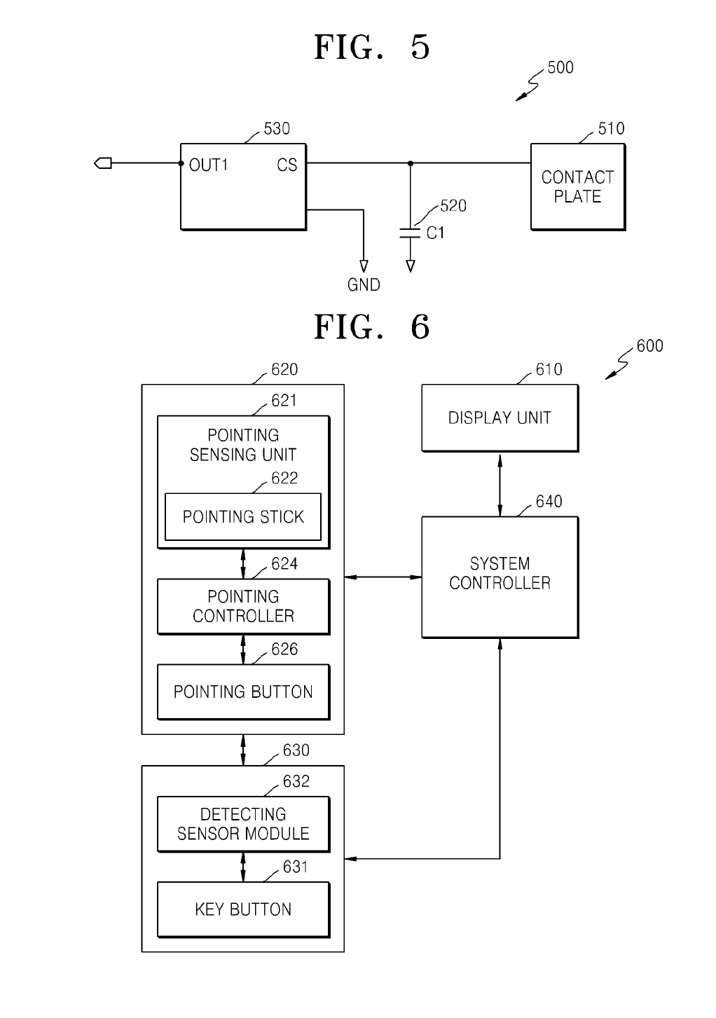

The detecting sensor module 332 is a sensor module to detect the approach or contact to a predetermined point. For example, the detecting sensor 332 may be a proximity sensor, a touch sensor, or the like. When a finger of the user approaches or contacts the key button 331 connected to the detecting sensor module 332, the detecting sensor module 332 may detect the approach or contact of the finger. It is possible that the detecting sensor module 332 may detect a conductive object, for example, a user finger, etc., or a non-conductive object, for example, a stylus, a pen, a user finger with a glove, etc. The detecting sensor module 332 will be described in detail later with reference to FIG. 5.

Operation 210 of FIG. 2 may be performed by the detecting sensor module 332 of FIG. 3. It is possible that operation of FIG. 2 may be performed by the detecting sensor module 332 and the system controller 340 of FIG. 3

When the manipulation of the pointing button 321 is detected, the system controller 340 performs or does not perform an operation corresponding to the manipulation of the pointing button 321 based on the detecting result of the detecting sensor module 332. The system controller 340 may determine whether an operation is performed to correspond to the manipulation of the pointing button 321 according to a signal of the detecting sensor module 332.

Operation 230 of FIG. 2 may be performed by the system controller 340 of FIG. 3.

FIGS. 4A and 4B are diagrams illustrating the pointing module 320 and the keyboard unit 330 of FIG. 3. Also, FIGS. 4A and 4B are diagrams respectively illustrating predetermined regions 410 and 460 corresponding to the predetermined region 175 of FIG. 1B. Also in FIGS. 4A, and 4B, the pointing module 320 includes two pointing buttons. For example, the pointing button on the left is a selecting key and the pointing button on the right is a key for carrying out a predetermined operation.

FIG. 4A illustrates an arrangement of a detecting sensor module 430 according to an embodiment of the present general inventive concept, and FIG. 4B illustrates an arrangement of a detecting sensor module 485 according to an embodiment of the present general inventive concept.

In FIG. 4A, pointing buttons 421 and 422 and a key button 450 disposed adjacent to the pointing buttons 421 and 422 respectively correspond to the pointing button 321 and the key button 331 of FIG. 3. Although FIG. 4A illustrates that the one key button 450 is disposed adjacent to the pointing buttons 421 and 422, it is possible that one or more key buttons may be disposed adjacent to the pointing buttons 421 and 422. Also, the key button 450 may be a space key button of the keyboard unit 330. However, the present general inventive concept is not limited thereto. It is possible that the key button 450 may be another key button than the space key button according to a location of the pointing buttons and an arrangement of key buttons of the keyboard unit 330.

Referring to FIG. 4A, the pointing module 320 may include a pointing stick 423 and the pointing buttons 421 and 422.

The detecting sensor module 430 may be disposed between the pointing buttons 421 and 422 and the key button 450. The detecting sensor module 430 may be disposed closer to the key button 450 than the pointing buttons 421 and 422.

A manipulating operation of the pointing module 320 by a user will now be described with reference to FIG. 4A.

The pointing stick 423 points at a predetermined point (position) on a predetermined screen displayed on the display unit 310. The user may manipulate the pointing stick 423 to move a pointer to a location of the pointed predetermined point. When the pointer is at a desired point, the user may manipulate at least one of the pointing buttons 421 and 422 so that a desired operation is performed.

The pointer may be disposed at a desired point corresponding to an icon, a function key, or a menu item, etc., such that at least one operation of the portable computer 300 can be performed according to the selection of at least one of the pointing buttons 421 and/or 422.

The pointing stick 423 may be disposed at a position between key buttons or at a position near the pointing buttons 421 and 422. The pointing stick 423 may be disposed between a key button and the pointing button 421 or 422. The pointing stick 423 may be disposed at a position close to the key button 450 and away from the pointing button 421 or 422. The pointing buttons 421 and 422 may be disposed in an area where the key buttons are disposed in a keyboard unit of the portable computer.

The user may click the pointing button 421 with a finger 451 to select a menu item, for example, at the predetermined point where the pointer is located. It is possible that the user may click the pointing button 422 with a finger 455 so that a predetermined process or operation is performed.

If a finger of the user moves to press the key button 450, the finger may be located at a position 453 or 455. When the detecting sensor module 430 detects that the finger approaches the key button 450, and transmits the detecting result to at least one of the system controller 340 and the pointing module 320 of FIG. 3.

When the approach or contact to the key button 450 is detected, the system controller 340 does not perform an operation corresponding to the manipulation of one of the pointing buttons 421 and 422, for example, the pointing button 421, even if the manipulation of the pointing button 421 is detected.

When the approach or contact to the key button 450 is not detected, the system controller 340 performs the operation corresponding to the manipulation of one of the pointing buttons 421 and 422, for example, the pointing button 421, if the manipulation of the pointing button 421 is detected.

When the pointing button 421 or 422 is pressed by mistake or inadvertently while pressing the key button 450, the system controller 340 uses the detecting result of the detecting sensor module 332 to determine whether to perform the operation corresponding to the manipulation of the pointing button 421 or 422 when the approach or contact to the key button 450 is detected, thereby performing a signal process which is intended by the user.

The detecting sensor module 430 may be disposed between a key button and the pointing button 421 or 422. The detecting sensor module 430 may be disposed within an area defined by the key button, the pointing buttons 421 and 422, and lines connecting corresponding corners of the key button and the pointing button 421 and 422. The detecting sensor module 430 may be disposed to detect a movement of the key button 450 or a change of a current state of the key button 450 before a switch of the key button 450 is activated according to the movement of the key button 450 by a user. It is also possible that the detecting sensor module 430 is disposed to detect an existence of an object over the key button 450. The detecting sensor module 430 may be disposed to detect a movement of the key button 450 or a change of a current state of the key button 450 when a switch of the key button 450 is activated according to the movement of the key button 450 by a user. The detecting sensor module 430 may not be disposed to detect a movement of the pointing button 421 or 422 or a change of a current state of the pointing button 421 or 422.

FIG. 4B is a diagram illustrating an arrangement of a detecting sensor module 485 according to an embodiment of the present general inventive concept.

A pointing stick 473, pointing buttons 471 and 472, and a key button 481 disposed adjacent to the pointing buttons 471 and 472 in FIG. 4B respectively correspond to the pointing stick 423, the pointing buttons 421 and 422, and the key button 450 of FIG. 4A, and thus, detail descriptions thereof will not be repeated herein.

Referring to FIG. 4B, the detecting sensor module 485 may be disposed inside the key button 481. The detecting sensor module 485 may be disposed below the key button 481 to detect a finger approaching the key button 481. Also, the detecting sensor module 485 may be disposed parallel to the pointing button 471 and 472 near the pointing buttons 471 and 472.

When the user clicks at least one of the pointing buttons 471 and 472, fingers 491 and 492 may be placed on the pointing buttons 471 and 472 as illustrated in FIG. 4B. Also, as the portable computer 300 is miniaturized, the sizes of the keyboard unit 330 and pointing button 321 are decreased. Thus, when the user clicks the pointing buttons 471 and 472, the finger may be outside the pointing buttons 471 and 472. When the detecting sensor module 485 is disposed inside the key button 481, the approaching of the finger is not detected as long as the finger is located above the key button 481 even if the finger is partially outside the pointing buttons 471 and 472 as illustrated in FIG. 4B.

Accordingly, when the detecting sensor module 485 is disposed inside the key button 481, the finger approaching to push the key button 481 is more accurately detected.

FIG. 5 is a diagram illustrating the detecting sensor module 332 of FIG. 3.

Referring to FIG. 5, the detecting sensor module 332 may include a proximity sensor module 500 to detect a finger of a user approaching the key button 331.

In FIG. 5, the proximity sensor module 500 may include a contact plate 510, a capacitor 520, and a detection signal generator 530.

The contact plate 510 detects approach or contact of the user. The contact plate 510 may be connected to one end of the capacitor 520, and may be a region that the finger approaches or contacts.

The capacitor 520 is charged or discharged based on whether the user approached or contacted the contact plate 510. The capacitor 520 may be a capacitive capacitor C1 charged or discharged according to approach or contact of the user. For example, if the finger contacts the contact plate 510, the capacitive capacitor C1 is charged, and thus, a signal having a charge voltage level is input to a circuit switched (CS) terminal CS of the detection signal generator 530. When the signal having the charge voltage level is input to the CS terminal CS, the detection signal generator 530 determines that the finger approached or contacted the contact plate 510.

The detection signal generator 530 generates a detection signal OUT1 according to a voltage charged in the capacitor 520. For example, when the capacitor 520 detects the approach or contact of the user, the detection signal generator 530 may generate and outputs the detection signal OUT1, and when the capacitor 520 does not detect the approach or contact of the user, the detection signal generator 530 may not generate and output the detection signal OUT1.

It is possible that the detection signal generator 530 can generate the detection signal OUT1 having an activated level when at least one of the approach and contact is detected, and generate the detection signal OUT1 having a deactivated level when at least one of the approach and contact is not detected.

FIG. 6 is a block diagram illustrating a portable computer 600 according to an embodiment of the present general inventive concept.

Referring to FIG. 6, the portable computer 600 includes a display unit 610, a pointing module 620, a keyboard unit 630, and a system controller 640.

The display unit 610, the pointing module 620, the keyboard unit 630, and the system controller 640 of FIG. 6 may respectively correspond to the display unit 310 the pointing module 320, the keyboard unit 330, and the system controller 340 of FIG. 3, and thus, detail descriptions thereof will be omitted here.

The pointing module 620 may include a pointing sensing unit 621, a pointing controller 624, and at least one pointing button 626.

The pointing sensing unit 621 includes a pointing stick 622 to point or indicate a predetermined point. The pointing sensing unit 621 detects the predetermined point pointed by the pointing stick 622. The pointing sensing unit 621 may generate a predetermined coordinate value from a location of the predetermined point pointed by the pointing stick 622.

The at least one pointing button 626 is at least one button to select or process an item displayed at the predetermined point pointed by the pointing stick 622. Since the pointing button 626 are similar or identical to the pointing button 321 of FIG. 3, descriptions thereof will omitted here.

The pointing controller 624 detects manipulation of the pointing button 626, and generates a command corresponding to the detected manipulation of the pointing button 626. Then, the pointing controller 624 transmits the generated command to the system controller 640. For example, when the pointing button 626 is a selection button indicating selection of a pointed or predetermined menu item, the pointing controller 624 detects that the selection button is pressed when the pointing button 626 is pressed. Since the selection button is pressed, the pointing controller 624 generates a command to select the predetermined menu item.

The pointing controller 624 transmits the command to select the predetermined menu item to the system controller 640. Then, the system controller 640 performs an operation corresponding to the selected menu item according to the received command. For example, when the predetermined menu item is a predetermined program, the system controller 640 may execute the program according to the command.

The keyboard unit 630 includes at least one key button 631 disposed adjacent to the at least one pointing button 626, and a detecting sensor module 632 to detect at least one of approach and contact to the at least one key button 631. The at least one key button 631 and the detecting sensor module 632 respectively correspond to the at least one key button 331 and the detecting sensor module 332 of FIG. 3, and thus, detail descriptions thereof will not be repeated herein.

The detecting sensor module 632 may transmit a detecting result representing the detecting at least one of approach and contact to the at least one key button 631 to at least one of the pointing controller 624 and the system controller 640. The detecting sensor module 632 may transmit a detection signal representing the detecting result to at least one of the pointing controller 624 and the system controller 640.

Also, the pointing controller 624 and the system controller 640 may be connected via an interface to transmit or receive data. For example, the pointing controller 624 and the system controller 640 may be connected via a personal system (PS)/2 interface or a universal serial bus (USB) interface, for example.

Control operations of the system controller 640 will now be described when the detecting sensor module 632 transmits the detecting result to the system controller 640.

The system controller 640 monitors the detecting result of the detecting sensor module 632. Then, upon receiving the command transmitted from the pointing controller 624, the system controller 640 performs or does not perform the operation corresponding to the command, according to the monitored detecting result.

When the detecting sensor module 632 transmits the detecting result to the system controller 640, i.e., when the system controller 640 directly monitors the detecting result of the detecting sensor module 632, the system controller 640 may determine whether to ignore the command transmitted from the pointing controller 624 according to the monitored detecting result.

The monitoring may be performed as the system controller 640 checks the detecting result of the detecting sensor module 632 at predetermined time intervals or in real time. Also, when the manipulation of the at least one pointing button 626 is detected, the system controller 640 may check the detecting result of the detecting sensor module 632.

The system controller 640 may not perform the operation corresponding to the command when at least one of the approach and contact of the user is detected, and may perform the operation corresponding to the command when at least one of the approach and contact is not detected.

For example, when the finger approaches or contacts the at least one key button 631, the detecting sensor module 632 may output the detection signal in an activated level, for example, a logic high level. Upon receiving the detection signal having the logic high level, the system controller 640 determines that the approach or contact is performed and ignores the manipulation of the pointing button 626.

Control operations of the pointing controller 624 will now be described when the detecting sensor module 632 transmits the detecting result to the pointing controller 624.

The pointing controller 624 monitors the detecting result of the detecting sensor module 632. Then, the pointing controller 624 may ignore the manipulation of the pointing button or perform the operation corresponding to the manipulation of the pointing button 626 according to the monitored detecting result.

The pointing controller 624 ignores the manipulation of the pointing button 626 when at least one of the approach and contact of the user is detected, according to the monitored detecting result. Also, the pointing controller 624 performs the operation corresponding to the manipulation of the pointing button 626 if at least one of the approach and contact of the user is not detected.

The pointing controller 624 may not generate the command corresponding to the manipulation of the pointing button 626 when at least one of the approach and contact is detected, according to the monitored detecting result. It is possible that the pointing controller 624 can generate the command corresponding to the manipulation of the pointing button 626 when the manipulation of the pointing button 626 is detected, but may not transmit the command to the system controller 640. The pointing controller 624 generates the command corresponding to the manipulation of the pointing button 626 when at least one of the approach and contact of the user is detected, according to the monitored detecting result.

When at least one of the approach and contact of the user is detected via a monitoring process, the pointing controller 624 may ignore the manipulation of the pointing button 626 even if the user manipulates the pointing button 626.

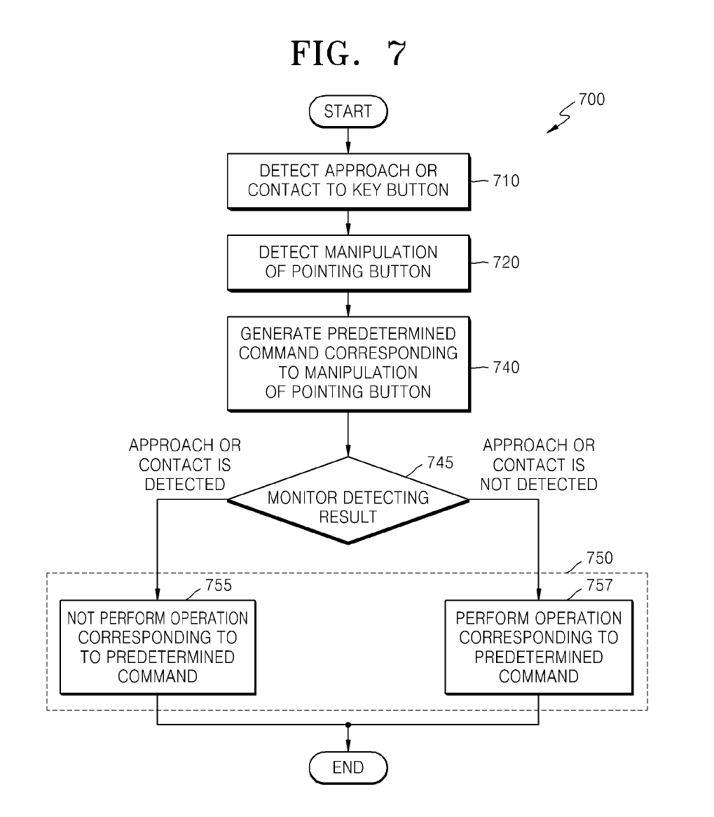

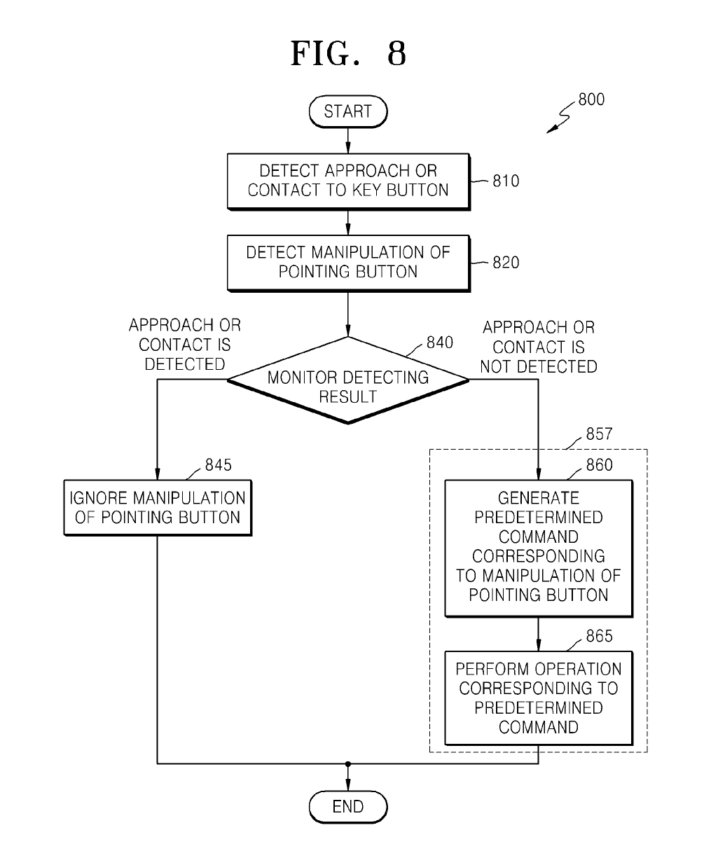

FIGS. 7 and 8 illustrate methods 700 and 800 of processing a signal of a portable computer according to embodiments of the present general inventive concept. The methods 700 and 800 of FIGS. 7 and 8 may be performed in the portable computer 600 of FIG. 6. Also, operations of the methods 700 and 800 of FIGS. 7 and 8 correspond to operations of the portable computer 600, and thus detail descriptions thereof will be omitted.

FIG. 7 is a flowchart illustrating the method 700 of processing a signal of a portable computer, according to an embodiment of the present general inventive concept. Since operations 710 and 720 of FIG. 7 respectively correspond to operations 210 and 220 of FIG. 2, detail descriptions thereof will be omitted here.

Referring to FIGS. 6 and 7, the method 700 is performed in the portable computer 600 including the at least one pointing button 626 and the at least one key button 631 disposed adjacent to the at least one pointing button 626.

According to the method 700, at least one of the approach and contact to the at least one key button 631 disposed adjacent to the at least one pointing button 626 is detected by using the detecting sensor module 632, in operation 710. Operation 710 may be performed by the detecting sensor module 632.

The manipulation of the at least one pointing button 626 is detected in operation 720. Operation 720 may be performed by the pointing controller 624.

The corresponding command corresponding to the manipulation of the pointing button 626 is generated in operation 740. Operation 740 may be performed by the pointing controller 624. Also, the command generated in operation 740 is transmitted from the pointing controller 624 to the system controller 640.

Then, the detecting result of the detecting sensor module 632 is monitored in operation 745. Operation 745 may be performed when the manipulation of the pointing button 626 is detected in operation 720, and may be performed in real time or at predetermined time intervals. Operation 745 may be performed by the system controller 640. The system controller 640 may receive the detecting result of operation 710 to perform the monitoring operation 745.

The command generated in operation 740 may be ignored or the operation corresponding to the command may be performed in operation 750, based on the monitoring result of operation 745. Operation 750 may be performed by the system controller 640.

In operation, the operation corresponding to the command generated in operation 740 is not performed in operation 755, if at least one of the approach and contact of the user is detected based on the monitoring result of operation 745. Operation 755 may be performed by the system controller 640.

The operation corresponding to the command generated in operation 740 is performed in operation 757, if at least one of the approach and contact of the user is not detected based on the monitoring result of operation 745. The method of FIG. 7 determines a priority to be given to the key button or the pointing button such that an operation corresponding to at least one of the key button or the pointing button can be performed according to the determined or given priority when the corresponding key and/or pointing buttons are manipulated as described above.

FIG. 8 is a flowchart illustrating the method 800 of processing a signal of a portable computer according to an embodiment of the present general inventive concept. Since operations 810 and 820 of FIG. 8 respectively correspond to operations 710 and 720 of FIG. 7, detail descriptions thereof will be omitted.

The detecting result of the detecting sensor module 632 is monitored in operation 840. Operation 840 may be performed when the manipulation of the pointing button 626 is detected in operation 820, and may be performed in real time or at predetermined time intervals. Operation 840 may be performed by the pointing controller 624. In other words, the detecting result of operation 810 may be received by the pointing controller 624 to perform the monitoring of operation 840.

The manipulation of the pointing button 626 is ignored in operation 845 if at least one of the approach and contact of the user is detected, according to the monitored detecting result of operation 840. It is possible that an operation corresponding to the manipulation of the pointing button 626 may be prevented in operation 845. It is also possible that a command corresponding to the manipulation of the pointing button 626 may be prevented in operation 845. Operation 845 may be performed by the pointing controller 624. The pointing controller 624 may not generate a command corresponding to the manipulation of the pointing button 626. Alternatively, the pointing controller 624 may generate the command but may not transmit the command to the system controller 640.

The operation corresponding to the manipulation of the pointing button 626 may be performed or may not be performed in operation 857, according to the monitored detecting result of operation 840. Operation 857 may be performed by the pointing controller 624 and the system controller 640.

The command corresponding to the manipulation of the pointing button 626 may be generated in operation 860 when one of the approach and contact of the user is not detected, according to the detecting result monitored in operation 840.

Then, the operation corresponding to the command generated in operation 860 is performed in operation 865. Operation 865 may be performed by the system controller 640. The command generated in operation 860 may be transmitted to the system controller 640. Then, the system controller 640 may perform the operation corresponding to the received command.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the method and the portable computer of the embodiment of the present general inventive concept, the manipulation of the pointing button is ignored or an operation corresponding to the manipulation of the pointing button and the generation of a command corresponding to the manipulation of the pointing button is prevented when the approach or contact to the key button adjacent to the pointing button is detected, even if the user manipulates the pointing button. Accordingly, an unintended operation that may be generated when the pointing button is pressed by mistake or inadvertently while the user is pressing the key button adjacent to the pointing button may be prevented. Thus, the method and the portable computer may operate more suitably according to the intention of the user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A portable computer comprising:
a display unit to display a predetermined screen;
a pointing module comprising at least one pointing button to point or select a predetermined point on the predetermined screen;
a keyboard unit comprising at least one key button disposed adjacent to the at least one pointing button, and a detecting sensor module to detect at least one of approach and contact to the at least one key button; and
a system controller to determine whether to perform an operation corresponding to manipulation of the at least one pointing button based on a detecting result of the detecting sensor module when the at least one pointing button is manipulated.

2. The portable computer of claim 1, wherein the system controller does not perform the operation corresponding to the manipulation of the at least one pointing button if at least one of the approach and contact is detected.

3. The portable computer of claim 1, wherein the system controller performs the operation corresponding to the manipulation of the at least one pointing button if at least one of the approach and contact is not detected.

4. The portable computer of claim 1, wherein the pointing module comprises:
a pointing sensing unit comprising a pointing stick to point at the predetermined point, and to detect the predetermined point pointed by the pointing stick such that the at least one pointing button selects a menu item at the predetermined point or performs a predetermined process on the menu item at the predetermined point; and
a pointing controller to detect the manipulation of the at least one pointing button, and to generate and transmit a command corresponding to the detected manipulation of the at least one pointing button to the system controller.

5. The portable computer of claim 4, wherein the system controller monitors the detecting result of the detecting sensor module, and performs or does not perform an operation corresponding to the command.

6. The portable computer of claim 5, wherein the system controller does not perform the operation corresponding to the command if at least one of the approach and contact is detected and performs the operation corresponding to the predetermined command if at least one of the approach and contact is not detected, based on the monitored detecting result.

7. The portable computer of claim 4, wherein the pointing controller monitors the detecting result of the detecting sensor module, and ignores the manipulation of the at least one pointing button or performs the operation corresponding to the manipulation of the at least one pointing button based on the monitored detecting result.

8. The portable computer of claim 7, wherein the pointing controller ignores the manipulation of the at least one pointing button if at least one of the approach and contact is detected, and performs the operation corresponding to the manipulation of the at least one pointing button if at least one of the approach and contact is not detected.

9. The portable computer of claim 8, wherein the pointing controller does not generate the command corresponding to the manipulation of the at least one pointing button if at least one of the approach and contact is detected, and generates the command corresponding to the manipulation of the at least one pointing button if at least one of the approach and contact is not detected.

10. The portable computer of claim 1, wherein the detecting sensor module comprises a proximity sensor module having:
a contact plate to detect approach or contact of a user;
a capacitor to be charged or discharged based on whether the contact plate detected the approach or contact of the user; and
a detection signal generator to generate a detection signal based on a voltage charged in the capacitor.

11. The portable computer of claim 10, wherein the detection signal generator generates the detection signal having an activated level if at least one of the approach and contact is detected, and does not generate the detection signal or generates the detection signal having a deactivated level if at least one of the approach and contact is not detected.

12. The portable computer of claim 1, wherein the detecting sensor module is disposed between the at least one pointing button and the at least one key button disposed adjacent to the at least one pointing button.

13. The portable computer of claim 1, wherein the detecting sensor module is disposed inside the at least one key button disposed adjacent to the at least one pointing button.

14. A method of processing a signal of a portable computer comprising a keyboard comprising at least one pointing button and at least one key button disposed adjacent to the at least one pointing button, the method comprising:
detecting at least one of approach and contact to the at least one key button by using a detecting sensor module;
detecting manipulation of the at least one pointing button; and
performing or not performing an operation corresponding to the manipulation of the at least one pointing button based on the detecting result of the detecting sensor module.

15. The method of claim 14, further comprising monitoring the detecting result of the detecting sensor module.

16. The method of claim 15, further comprising:
generating a command corresponding to the manipulation of the at least one pointing button,
wherein the performing or not performing of the operation corresponding to the manipulation of the at least one pointing button comprises not performing the operation corresponding to the command if at least one of the approach and contact is detected and performing the operation corresponding to the predetermined command if at least one of the approach and contact is not detected, based on the monitored detecting result.

17. The method of claim 15, wherein the performing or not performing of the operation corresponding to the manipulation of the at least one pointing button comprises ignoring the manipulation of the at least one pointing button if at least one of the approach and contact is detected based on the monitored detecting result.

18. The method of claim 17, wherein the performing or not performing of the operation corresponding to the manipulation of the at least one pointing button comprises:
generating a command corresponding to the manipulation of the at least one pointing button if at least one of the approach and contact is not detected, based on the monitored detecting result; and
performing an operation corresponding to the command.

19. The method of claim 14, wherein the detecting of at least one of the approach and contact comprises:
disposing the detecting sensor module between the at least one pointing button and the at least one key button or inside the at least one key button; and
detecting at least one of the approach and contact by using the detecting sensor module.

20. A non-transitory computer-readable medium to contain computer-readable codes as a program to execute a method of processing a signal in a portable computer comprising a keyboard including at least one pointing button and at least one key button disposed adjacent to the at least one pointing button, the method comprising:
detecting at least one of approach and contact to the at least one key button by using a detecting sensor module;
detecting manipulation of the at least one pointing button; and
performing or not performing an operation corresponding to the manipulation of the at least one pointing button based on the detecting result of the detecting sensor module.

21. A portable computer comprising:
a display unit to display a predetermined screen;
a keyboard unit comprising a plurality of buttons to generate an input to the predetermined screen, and a detecting sensor module disposed adjacent one of the buttons to detect at least one of approach and contact to the one key button; and
a system controller to determine an operation of another button according to the detecting result of the detecting sensor module when the another button is activated.

22. The portable computer of claim 21, wherein the system controller determines a priority to be given to the another key button according to the detecting result of the detecting sensor module when the one key button and the another button are activated.
